(19) United States
(12) Patent Application Publication
(10) Pub. No.: US 2003/0120519 A1
(43) Pub. Date: Jun. 26, 2003

(54) Insurance method that accounts for the absence of the insured party

(76) Inventor: Alan A. Candos, Palos Heights, IL (US)

Correspondence Address: McAndrews, Held & Malloy, Ltd., 34th Floor, 500 West Madison Street, Chicago, IL, 60661, US

(21) Appl. No.: 10/036,124

(22) Filed: Dec. 26, 2001

(51) Int. Cl. G06F 17/60

(52) U.S. Cl. 705/4

(57) ABSTRACT

A homeowner's insurance method in which the insured identifies a neighbor who is empowered to file insurance claims on behalf of the homeowner when the homeowner is absent from the property. The neighbor is given a key to the insured property, inspects the property for damage, and files insurance claims for repair of damage. The neighbor works with the insurance company to carry out the repairs, and receives mailings from the insurance company as a potential customer of insurance.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The present invention relates to a method for managing insurance claims. More particularly, the invention relates to a method of handling homeowner's insurance claims in the absence of the insured party at some or all stages of the insurance claim process. In addition, the invention relates to a method of selling insurance by referrals from the insured.

Insurance companies generally process an insurance claim by performing a number of tasks that include the filing of a claim, information collection, loss estimation, communications between the insurance company and insured party, and satisfaction of the claim. Existing methods and systems for handling insurance claims are limited to processing claims and/or undertaking tasks only when authorized by the insured party. Therefore, an insurance claim may not be filed or acted upon in the absence of the insured party. This may result in ongoing damage to the insured property or allow for additional damage to occur. Further, the insured may be caused to travel many miles to return to the property solely for the reason of the insurance claim.

It is therefore an object of the present invention to manage an insurance claim despite the absence of the insured party.

It is yet another object of the present invention to manage the claim via a neighbor of the insured who has or may have an interest with the insured and not with the insurance company.

Another objective of the present invention is to organize and market insurance to those neighbors of an insured that do not have an existing relationship with the insurance agent or insurance company.

### BRIEF SUMMARY OF THE INVENTION

These and other objects of the invention are achieved in a method for processing insurance claims despite the absence of the insured party.

In the preferred embodiment, a neighbor is given a key to the insured property and empowered to file an insurance claim on behalf of the insured homeowner. Upon the occurrence of an insurance event, for example lightning damage to the home of the insured, an insurance claim is filed by the neighbor. The insurance company or an agent thereof then authorizes the insurance claim and repairs are made.

The neighbor is further empowered to approve satisfaction of an insurance claim in the absence of the insured party. More specifically, the neighbor is able to authorize the repair or replacement of the damaged property. The neighbor gives final approval of the action(s) undertaken in satisfaction of the insurance claim.

One advantage of the preferred embodiment is that the property owner, who previously had to be present to file, monitor, and approve satisfaction of an insurance claim may now accomplish one or all of these tasks through a neighbor. Another advantage, stemming from the use of the neighbor, is the prevention of ongoing or additional damage to the insured property due to delay in filing of an insurance claim.

The neighbor receives mailings regarding the insurance company and is purposefully targeted as a customer for future insurance purchases.

### DESCRIPTION OF THE DRAWINGS

FIG. 1 is a flow chart for an embodiment of establishing the policy, according to the present invention.

FIG. 2 is a flow chart for an embodiment of managing repair to the insured property.

FIG. 3 is a flow chart for an embodiment of managing the replacement of the insured property.

### DETAILED DESCRIPTION OF THE PREFERRED EMBODIMENT

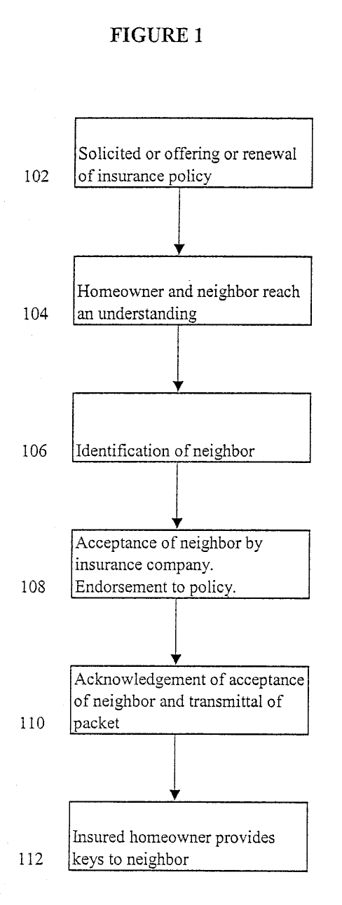

Referring to FIG. 1, a flow chart illustrates a method for handling insurance claims in the absence of the insured homeowner according to an embodiment of the present invention. The insurance method illustrated in FIG. 1 is tailored specifically for real estate insurance claims. However, other types of insurance claims such as personal property may also be used with the insurance method.

At step 102, a homeowner owner is solicited or offered an insurance policy. Alternatively, a preexisting insured homeowner is contacted regarding a renewal of the homeowner's present policy, or to modify it in accordance with the insurance method set out below. Typically, the insurance policy will insure the homeowner from loss due to damage by wind, storm, fire, etc. to the defined property.

The homeowner purchases, renews or modifies the insurance policy at step 102. This step may include the payment of funds by the homeowner and acceptance of the funds by the insurance company.

At step 104, the homeowner secures an understanding or agreement with at least one neighbor who is selected by the homeowner. Typically, this agreement will be reached subsequent to the purchase or renewal of the insurance policy, however, the agreement may be reached prior to or simultaneously with the purchase or renewal of the insurance policy. The agreement will set out the duties to be undertaken by the neighbor in the absence of the insured from the property and upon the occurrence of an insured event. The agreement may require that notice be given by the insured to the neighbor in a particular manner when the insured leaves the home and desires the neighbor's duties to be functioning. The neighbor may further agree to act on behalf of and in the best interests of the homeowner. A consideration may be stated as well so as to bind the neighbor. This understanding should be formalized in a written agreement at step 104. The agreement will bind the homeowner to the decisions of the neighbor. The agreement at step 104 may be established by the parties of their own accord or as a requirement of the insurance company.

At step 106, the insured communicates to the insurance company that a neighbor has agreed to the procedure. The neighbor is identified to the insurance company.

At step 108, an agreement occurs between the homeowner and the insurance company. This agreement takes the form of an endorsement or collateral agreement which is attached to the policy. The endorsement will identify and grant authority to a neighbor who is authorized to act on behalf of the homeowner with respect to certain particulars under the policy. This endorsement could occur (1) at the time of the purchase of the policy, (2) at a time subsequent to the purchase of the policy and during the policy's life, for example, at mid-policy term, or (3) at the time of renewal of the policy. The endorsement is made in a writing separate from the insurance policy. The writing may be merely a form prepared or filled out by the homeowner giving the neighbor's name, address and phone number or may be in the form of an additional agreement of terms as between the homeowner and the insurance company which amends or supplements the underlying policy.

The neighbor may be any third party including a family member, relative, friend, a person residing on the property, a person residing in the property adjacent to the insured property, or some other agent. The neighbor, in fact, may be an entity contracted to act on the homeowner's behalf including, but not limited to, a security agency, a lawn maintenance service, a building maintenance service, or a cleaning service, for example.

At step 108, the insurance company may perform a criminal record check or other investigation of the neighbor. In some cases, it may not be necessary that the neighbor is evaluated and formally accepted by the insurance company. However, the insurance company may require that the neighbor meet certain criteria preset by the insurance company and/or require a written agreement between the neighbor and the insurance company. For example, the insurance company may require the neighbor to reside on the property adjacent the insured property, or within a half mile distance from the property.

At step 110, the insurance company formally acknowledges to the neighbor that the neighbor has been accepted. An instructional packet of information is sent to the neighbor by the Insurance Company. This information may further elaborate on the duties of the neighbor and how to make contact with the insurance company. Importantly, the packet of information contains information about the insurance company in order to sell, or lay ground work to sell, insurance directly to the neighbor for the neighbor's own home or other needs. For example, the packet will include an invitation for that neighbor to receive additional information as to how this same program may be used for his or her property.

In the future, this neighbor may receive additional mailings, including regular updates on the plan, plan additions as well as annual authorization notification. Each mailing will include an offer of additional information regarding products for sale to the neighbor. Because of their repetitive nature, these mailings will become a valuable source for new business. Also, because of the interconnections that are made between the parties, this program method should prove to be a good retention tool.

At step 112, the insured homeowner gives a key to the neighbor to ensure that the neighbor has access to the insured property. In addition, the homeowner may give the neighbor a copy of the insurance policy and relevant contact information for contacting the insurance company upon the insured event and/or for contacting the homeowner away from the property. The key given to the neighbor may consist of one or more of the following, a key to the insured house, a key to the insured property, or an access code, combination, or password that provides access to the insured house or property. Alternatively, the homeowner may withhold the key until the time of absence.

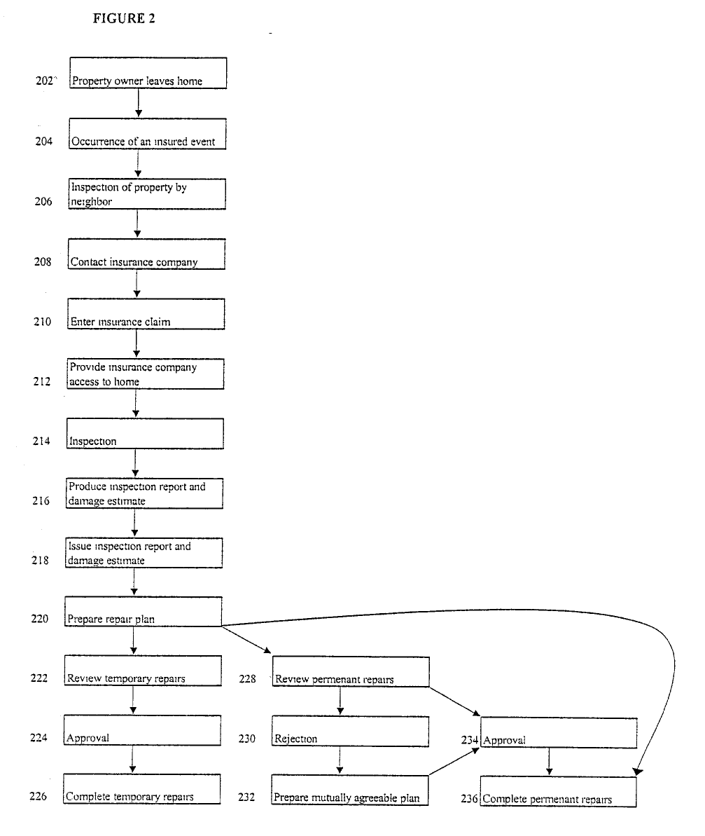

Referring to FIG. 2, at step 202, the insured homeowner leaves the property and notifies the neighbor accordingly. This notice will be in accordance with any agreement made at step 104.

At step 204, an insured event occurs while the homeowner is absent. The insured event includes any and all events claimable by the insured party under the insurance policy.

At step 206, the neighbor recognizes the occurrence of the event and inspects the property. The neighbor confirms that an insured event actually took place. The neighbor may also decide whether expediting repair to the damage is necessary to prevent further damage or whether to wait for the homeowner to return to the property. This requirement may be a condition upon which the neighbor is required to act per the agreement at step 104.

If the neighbor decides to act, at step 208, the neighbor contacts the insurance company or its representative insurance agent, and, at step 210, initiates a claim under the homeowner's insurance policy.

If necessary, at step 212, the neighbor will provide access to the property to a representative of the insurance company. At step 214, the representative inspects the insured home to determine the extent of damage. At step 216, the representative prepares an inspection report and damage estimate, and at step 218, provides the inspection report and damage estimate to the neighbor. The representative may, in step 218, also furnish a copy of the inspection report to the insured homeowner.

Typically, the insurance company's duties, which may include issuing a payment for the damage to the homeowner's property, are completed at step 218. However, the insurance company may offer a direct repair option, identifying preauthorized vendors, in the agreement at step 108. This, for example, would also give the insured or the authorized neighbor the option to choose their own vendors. Thus, a representative of the insurance company may, at step 220, also prepare a plan for repairing the insured home. This plan may consist of temporary and/or permanent repair steps. Temporary repairs are intended to prevent further damage to the insured property until return of the homeowner or until permanent repairs can be made. For example, the temporary repairs may include covering the property with plastic or other material.

At step 222, if the insurance company provides a plan for making temporary repairs, the neighbor reviews the temporary repairs proposed by the insurance company, and, at step 224, the neighbor approves the temporary repairs to be implemented. Steps 222 and 224 maybe a condition upon which the neighbor is required to act per the agreement reached at step 104. Moreover, the scope of the neighbor's authority in steps 222 and 224 may be limited by the agreement at step 104. Approval of the temporary repairs in step 224 may be made orally or in writing by the neighbor.

Typically, at step 226, the neighbor will select and hire repair persons to install the temporary repairs. In this step, the insurance company may provide a suggested list of vendors in which the neighbor may enlist to perform the temporary repairs. In the alternative, at step 226, the insurance company may directly implement the temporary repairs. This step includes the selection and hiring of repairpersons. This step further includes the oversight of the implementation of the temporary repairs according to the plan approved in step 224.

At step 228, if the insurance company provides a plan for permanent repairs, concurrently with step 222, or where no temporary repairs are needed, the neighbor reviews the permanent repair plan proposed by the insurance company at step 220. At step 228, the neighbor can reject or approve all or part of the proposed permanent repairs.

At step 230, the neighbor rejects all or part of the proposed permanent repairs by contacting the insurance company accordingly. The insurance company then, at step 232, works with the neighbor to prepare a mutually agreeable plan for permanent repair of the insured home.

At step 234, the neighbor approves the permanent repairs proposed by the insurance company. The scope of the neighbor's authority in steps 222 through 234 may be limited by the agreement at step 106.

Typically, at step 236, the neighbor will select and hire repair persons to perform the permanent repairs approved in step 234. Step 236 may be accomplished by the neighbor as well, where the insurance company provides no plan for repair and has completed its task at step 218. If the insurance company has completed its task at step 218, then the neighbor may prepare a repair plan at step 220. In this step 220, insurance company may provide a suggested list of vendors in which the neighbor may enlist to perform the permanent repairs, at step 236.

In the alternative, at step 236, the insurance company may directly implement the permanent repairs. This would include the selection and hiring of repairpersons. This would further include the oversight of the implementation of the permanent repairs by the neighbor according to the plan approved in step 234.

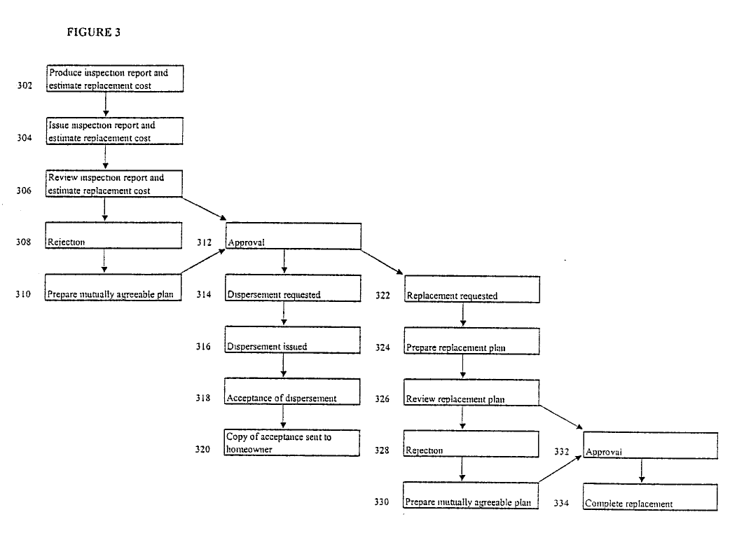

In some instances, however, repair of the insured property after an insured event is not practical and total replacement of the property will be effected. After the representative of the insurance company inspects the insured home to determine the extent of damage at step 214 and finds that repair is not practical, the representative prepares an inspection report and an estimate replacement cost at step 302 of FIG. 3. At step 304, the representative provides the inspection report and estimate replacement cost to the neighbor. The representative may also, in step 304, furnish a copy of the inspection report to the insured homeowner.

At step 306, the neighbor reviews the inspection report and estimate replacement cost prepared by the insurance company. During this review, the neighbor can reject or approve all or part of the inspection report or estimate replacement cost.

At step 308, the neighbor rejects all or part of the inspection report. The insurance company then, at step 310, works with the neighbor to prepare a mutually agreeable inspection report and/or estimate for replacement of the damaged property. The scope of the neighbor's authority in steps 306 through 310 may be limited by the agreement at step 104.

At step 312, the neighbor approves the inspection report and estimate replacement cost. Typically, the insurance company's duties, other than issuing a dispersement for the replacement costs, are completed at step 312. However, the insurance company may give the neighbor the choice of requesting that a dispersement check be issued or to request the insurance company's assistance in proceeding with replacement of the insured property. The scope of the neighbor's authority in this step may be limited by the agreement at step 104.

At step 314, the neighbor requests the insurance company to issue a dispersement check in the amount of the replacement costs agreed to in step 312. The insurance company issues the dispersement check in step 316. At step 318, the neighbor provides written acceptance of the dispersement check from the insurance company. A copy of the written approval is provided to the insured homeowner in step 320. The insurance claim process is now completed.

Alternatively, to requesting a dispersement check, the neighbor may request the insurance company's assistance in replacing the insured property at step 322. In step 324, a representative of the insurance company may prepare a plan for replacing the insured property. The neighbor reviews the replacement plan proposed by the insurance company at step 326. The neighbor can reject or approve all or part of the proposed replacement plan. This requirement maybe a condition upon which the neighbor is required to act per the agreement at step 104. Moreover, the scope of the neighbor's authority in this step may be limited by the agreement at step 104.

At step 328, the neighbor rejects all or part of the proposed permanent repairs. The insurance company then, at step 330, works with the neighbor to prepare a mutually agreeable plan for replacement of the insured property. At step 332, the neighbor approves the replacement plan proposed by the insurance company.

Typically, at step 334, the neighbor will select and hire repair persons to perform the replacement. In this step, the insurance company may provide a suggested list of vendors in which the neighbor may enlist to perform the replacement. In the alternative, at step 334, the insurance company may directly implement the replacement. This would include the selection and hiring of repairpersons.

It is understood that some of the steps listed above may be deleted or modified, and any of the steps may be modified or regulated under the existing insurance policy or the agreement between the homeowner and the third party. While particular elements, embodiments and applications of the present invention have been shown and described, it is further understood that the invention is not limited thereto since modifications may be made by those skilled in the art, particularly in light of the foregoing teaching. It is therefore contemplated by the appended claims to cover such modifications and incorporate those features which come within the spirit and scope of the invention.

1. A homeowner's insurance method which accounts for the absence of the homeowner from the insured home, comprising:
establishing an insurance policy between the insurance company and the homeowner for insuring a home;
establishing an agreement between an insurance company and a homeowner, including:
(1) identifying at least one neighbor of the home owner;
(2) acknowledging that said neighbor is authorized to act for the insured party;
providing a key to said neighbor for means of access to said home;
notifying said insurance company of the occurrence of an insured event;
submitting by said neighbor a claim under said insurance policy; and
making a performance on said claim by said insurance company under said insurance policy.

2. A method according to claim 1 wherein said step of establishing an agreement occurs subsequent to the step of establishing an insurance policy.

3. A method according to claim 1 wherein said insured event is damage to the home.

4. A method according to claim 3 and further including said insurance company submitting a written plan for repair of said damage.

5. A method according to claim 4 and further including approval by said neighbor of said plan for repair of said damage.

6. A method according to claim 5 wherein said step of making performance includes repairing said damage in accordance with said plan by a repairperson.

7. A method according to claim 1 wherein said step of making performance includes payment of monies by the insurance company.

8. A method according to claim 1 wherein said payment is made directly to a repair person.

9. A method according to claim 1 wherein said step of establishing an agreement includes an agreement in addition to said policy wherein said neighbor acknowledging in writing the duties of said neighbor.

10. A method according to claim 1 wherein said step of establishing an agreement includes an agreement in addition to said policy wherein said home owner agreeing in writing to be bound by decisions of said neighbor.

11. A method according to claim 1 wherein said occurrence of said insured event occurs at a time said home owner is absent from said home.

12. A method according to claim 1 wherein said step of notifying is performed by said neighbor.

13. A method according to claim 1 and further including said neighbor providing said insurance company with access to said home after said occurrence of said insured event.

14. A method according to claim 1 and further including said insurance company providing a damage estimate to said neighbor.

15. A method according to claim 1 and further including the step of inspection of said repair of said home.

16. A method according to claim 1 wherein said key is an access code, combination, or password that provides access to said home.

17. A method according to claim 1 wherein said neighbor resides on property adjacent to that occupied by said home.

18. A method according to claim 1 wherein said establishment of an insurance policy step consists of the renewal of an insurance policy.

19. An insurance method which accounts for the absence of a property owner from the insured property, comprising:
establishing an insurance policy between an insurance company and a property owner;
establishing an agreement between the insurance company and the property owner, including:
(1) identifying at least one neighbor of the property owner;
(2) acknowledging that said neighbor is authorized to act for the insured party;
providing a key to said neighbor for means of access to said property;
notifying said insurance company of the occurrence of an insured event;
submitting by said neighbor a claim under said insurance policy; and
making a performance on said claim by said insurance company under said insurance policy.

20. A method of selling insurance by using an insurance method which accounts for the absence of the homeowner from the insured home, comprising:
establishing an insurance policy between an insurance company and a homeowner for insuring a home;
establishing an agreement between the insurance company and the homeowner, including:
(1) identifying at least one neighbor of the home owner for notifying said insurance company of the occurrence of an insured event;
(2) communicating with said neighbor in connection with said policy, said communicating also providing information for selling insurance to said neighbor; and
providing a key to said neighbor for means of access to said home.
